(19) United States
(12) Patent Application Publication
(10) Pub. No.: US 2025/0370135 A1
(43) Pub. Date: Dec. 4, 2025

(54) VELOCIMETER IN THE MEDIUM INFRARED FOR MEASURING VELOCITY

(71) Applicant: COMMISSARIAT A L'ENERGIE ATOMIQUE ET AUX ENERGIES ALTERNATIVES, Paris (FR)

(72) Inventors: Yohan BARBARIN, Arpajon Cedex (FR); Jérôme LUC, Arpajon Cedex (FR)

(73) Assignee: COMMISSARIAT A L'ENERGIE ATOMIQUE ET AUX ENERGIES ALTERNATIVES, Paris (FR)

(21) Appl. No.: 18/874,904

(22) PCT Filed: Jun. 8, 2023
(86) PCT No.: PCT/FR2023/050817

§ 371 Date: Dec. 13, 2024

(30) Foreign Application Priority Data
Jun. 17, 2022 (FR) 2205890

(51) Int. Cl. G01S 17/58; G01S 7/481; G01S 17/88

(52) U.S. Cl. CPC G01S 17/58; G01S 7/4812; G01S 7/4818; G01S 17/88

(57) ABSTRACT

The invention relates to a device for measuring velocity, or a distribution of velocities, including at least one first laser radiation source that emits a laser beam with a wavelength of between 3 and 14 μm and at least one optical fibre for directing the radiation produced by the first laser source, from a first end of the fibre to a second end thereof. The device also includes detection means, for detecting an interference signal between a beam emitted by a laser source and a beam reflected by a sample; and processing means for processing the interference signal and to calculate a propagation velocity, or a distribution of velocities, of an object on which the incident or diffused beam was reflected.

### TECHNICAL FIELD AND PRIOR ART

The invention relates to the field of velocimetry, in particular in the medium infrared, for example for measuring shock or detonation velocity in materials.

One known technique for measuring shock velocities by Doppler effect uses a heterodyne velocimeter (HV). It makes it possible to make measurements through optically transparent materials with laser systems in the visible or in the infrared, such as for example the telecom wavelength (1550 nm). This technique, also called Fibre Doppler Interferometry (FDI) or Photonic Doppler Velocimetry (PDV), is for example described in the article by O T Strand et al., entitled “Compact system for high-speed velocimetry using heterodyne techniques”, Review of Scientific Instruments, Vol. 77, 083108, (2006). It makes it possible to measure the velocities of movement of an object by measuring the Doppler frequency with a laser sight at a given wavelength.

A related and older technique, described in D H Dolan, “Foundations of VISAR analysis”, SANDIA REPORT 1950, (2006), makes it possible to measure the movement or velocity of movement by analysing the phase shift of the interferometric signal by means of a homodyne velocimeter, also referred to as Fibre Velocity interferometry (FVI) or VISAR (“Velocity Interferometer System for Any Reflector”).

Moreover, a radio-interferometric technique is known (“RIF”, or “Microwave Interferometry”), described in the article by V M Bel'skii et al., entitled “Microwave diagnostics of shock-wave and detonation .processes”, which appeared in Combustion, Explosion and Shock Waves, Vol 47, No 6, pp. 639-650, (2011). This technique makes it possible to make measurements through radiotransparent materials with radio-interferometric systems, at frequencies typically between 10 GHz and 100 GHz.

The systems of the “HV” type have very good temporal and spatial resolution but the core measurements, at the interior of the material, are greatly limited, since few study materials are transparent at the wavelength concerned. Offset measurement is possible with optical fibres with very few losses.

“RIF” systems can probe a large number of materials, but not metals. The spatial resolution thereof is greatly limited by the long wavelength (>3 mm at 100 GHz) and the beam emitted in the material, not completely collimated, has a diameter of approximately 20 mm. The temporal resolution of such a system is also limited with few interference fringes during the short period that a shock typically lasts for (between 1 and 10 μs). Offset measurement is possible but limited to a few metres (˜5 m) since the flexible waveguide used, made from Teflon, causes many dielectric losses.

In the known systems (HV and RIF systems), either it is not possible to probe the core of a large number of materials, or the spatial and temporal resolutions are insufficient. Moreover, the losses for transporting the signal are limited and the necessary bandwidth greater, or vice versa.

The problem is then posed of finding a novel device and a novel method for making velocity measurements, inside an object or a material, beyond the external surface thereof, preferably offset with respect to this object or this material.

Preferably such a device or method must make it possible to obtain good spatial and/or temporal resolutions.

In particular, from the temporal point of view, such a method or device must be compatible with rapid phenomena occurring over a total period of the order of a few μs, for example of the order of 10 μs.

From the spatial point of view, such a device or method must preferably make it possible to obtain a spatial resolution making it possible to obtain precise information, of the order of a millimetre.

### DESCRIPTION OF THE INVENTION

The invention relates first of all to a velocity-measurement device, including:
at least one first laser radiation source that emits a laser beam with a wavelength of between 3 μm and 14 μm;
at least one optical fibre for directing a radiation, or at least part of the radiation, produced by the first laser source, from a first end of the fibre to a second end thereof;
detection means, for detecting an interference signal between at least one beam emitted by a laser source and a beam, reflected or diffused, for example by a sample or an object, or a part of a sample or of an object; in the “homodyne” case, this beam emitted by a laser source can be retransmitted by the fibre; or, in the “heterodyne” case, the detection means make it possible to detect an interference signal between a beam emitted by a second laser source and the beam of said first laser source, which was reflected or diffused for example by a part of a sample or of an object and retransmitted by the fibre;
preferably processing means, able to process the interference signal and to calculate a propagation velocity, or a distribution of velocities, of a sample or of an object, or of a part of a sample or of an object, for example of a physical discontinuity (for example a shock front) at the core of this sample or of the object, on which the incident beam was reflected or diffused.

In a homodyne version of the device, the detection means make it possible to detect an interference signal between at least one beam emitted by the first laser source and the beam reflected or diffused by a sample or an object.

In a heterodyne version of the device, the detection means make it possible to detect an interference signal between at least one beam emitted by a second laser source and the beam reflected or diffused by a sample or an object.

The beam reflected or diffused by a sample or an object can be retransmitted by the optical fibre that directs it from its second end to its first end. A device according to the invention can include means for combining and causing to interfere a part of the radiation produced by a laser source (the first laser source in the homodyne case; the second laser source in the heterodyne case) and the part, reflected or diffused by a sample of an object, of the radiation that comes from the first laser source.

The invention makes it possible to work in a wavelength band located in the medium infrared, preferably between 3 μm and 14 μm, in other words in the frequency domain between approximately 20 THz and 100 THz.

Selecting this wavelength domain proves to be highly advantageous since many materials, including explosive materials (TNT (or trinitrotoluene, C₇H₅N₃O₆), RDX (or cyclo-trimethylene-trinitramine, C³H⁶N₆O₆), HMX (or cyclo-tetramethylene-tetranitramine, C₄H₈N₈O₈), are transparent in this spectral range.

Selecting this wavelength domain moreover proves to be highly advantageous for probing in more depth clouds of moving particles, for example particles of a gas. For example again, particles are ejected or projected, the finest of which, which are more rapid, are in front and mask the coarse ones, which are slower and are therefore behind. The invention makes it possible to know the velocity distributions of all or some of the particles ejected or projected (spectrograms).

At least one laser radiation source, for example the first and/or the second laser radiation source, of a device according to the invention is for example a QCL (“Quantum Cascade Laser”) laser source or an ICL (“Interband Cascade Laser”) laser source or a continuous laser source, preferably compact. Preferably, at least one laser source has a small line width (preferably less than 1 MHz) in order to have better contrast on the interference fringes and to be able to increase the length of the optical fibre (or offset fibre). The smaller the line width of a laser source, the more “coherent” it is and the greater the “coherence length”. The coherence length is the maximum distance between two signals that makes it possible to create interferences (fringes). Here it is approximately the round-trip length of the optical fibre.

The spatial and temporal resolutions of a device according to the invention are 5 to 10 times less than those of the HV systems but 300 to 1000 times greater than those of the RIF systems.

The signal can be transported by a solid glass fibre or a fibre of the monomode and/or microstructured type, or with a hollow core; this fibre is for example produced from a glass with a Te₂As₃Se₅ composition (“TAS” glass).

In a device according to the invention, the interference-signal processing means are for example able to produce at least one sliding Fourier transform of the interference signals or a wavelet transform of these signals.

In a variant of a device according to the invention, it furthermore includes means for phase shifting part of the beam emitted by a laser source and part of the beam reflected or diffused by a sample and means for detecting an interference signal between these out-of-phase beams, said interference-signal processing means being able to implement at least one two-phase processing.

A device according to the invention can furthermore have one or more of the following features:
the bandwidth of the rapid detection means can be reduced by a factor of 2 to 20 compared with that of the HV systems. This bandwidth is, for all the systems, proportional to the velocity be to be measured. It is for example approximately 1.6 GHz for a velocity of 8000 m/s at 10 μm of wavelength; a bandwidth of between 20 MHz (<1 GHz) and 2 GHz is in particular adapted to the range of wavelengths of between 3 μm and 14 μm, for example for applications measuring velocity of between 100 m/s and 10,000 m/s;
and/or the losses by attenuation caused by the transport of the signal are also reduced compared with the RIF systems; they are for example limited to less than 5 dB/m, for example to approximately 1 dB/m;
and/or the first laser radiation source and/or the second laser radiation source produces a beam the diameter of which is less than 5 mm or less than 3 mm, in particular at a distance corresponding to a sample in which it is wished to measure a velocity;
and/or the device furthermore includes collimation means, preferably directly applied against a sample.

The invention also relates to a velocity measurement method, or velocimetry, preferably using a device according to the invention, as described above or in the present application, including the following steps:
sending, to an object or a sample of a solid or liquid material, for example a cloud of particles, to be analysed, incident laser radiation with a wavelength of between 3 and 14 μm;
taking radiation reflected or diffused by said object or sample, or by an interior part of the object or of the sample, in response to the incident laser radiation;
detecting an interference signal between a part taken from the reflected or diffused radiation and the incident laser radiation (the homodyne case); or detecting an interference signal between a part taken from the emitted radiation and a second laser radiation emitted by a second laser source (the heterodyne case).

The velocity, or the distribution of velocities, can be calculated from the interference signal or signals.

The invention also relates to a method for measuring velocity, or a distribution of velocities, using a device according to the invention, as described above or in the present application, wherein:
the second end of the optical fibre is directed towards an object or sample, for example a cloud of particles inside which a velocity of a movement, or a distribution of velocities of movements (a spectrogram), is to be detected,
the incident beam of the first laser source penetrates the object or the sample, and is reflected or diffused on an interior part of the object or of the sample, which moves at a velocity V or in accordance with a distribution of velocities (for example in the case of a cloud of particles);
the reflected or diffused beam and a part of the beam emitted by the first source form interferences detected by the detection means (the homodyne case); or the reflected or diffused beam and a part of the beam emitted by a second laser forming interferences detected by the detection means (the heterodyne case).

There again, the velocity, or the distribution of velocities, can be calculated from the interference signal or signals.

According to a particular embodiment of the method according to the invention, a shock or a detonation is produced inside the object or sample, the incident laser beam being reflected or being diffused on a wavefront produced by the shock or the detonation. For example, the object or the sample includes an explosive material such as TNT (or trinitrotoluene, C₇H₅N₃O₆), or RDX (or cyclo-trimethylene-trinitramine, C₃H₆N₆O₆), or HMX (or cyclo-tetramethylene-tetranitramine, C₄H₈N₈O₈), or an inert material.

According to another particular embodiment of a method according to the invention, the object is, or includes, a channel or a pipe or a tube inside which a fluid moves, the incident laser beam being reflected or being diffused on moving particles contained in the fluid.

According to another particular embodiment of a method according to the invention, a plurality of laser beams are directed towards the object.

Whatever the embodiment envisaged, the velocity can be calculated by sliding Fourier transform or by wavelet transform of the interference signals or by two-phase processing.

### BRIEF DESCRIPTION OF THE DRAWINGS

FIG. 1 is an example embodiment of a device according to the invention, in homodyne version.

FIG. 2 is an example embodiment of a device according to the invention, in heterodyne version.

FIG. 3 is an example embodiment of a device according to the invention, with phase processing.

FIG. 4 shows an application of a device according to the invention to a measurement on a cloud of particles.

FIG. 5 shows schematically collimation means applied against a sample in the context of an implementation of the invention.

FIG. 6 shows schematically collimation means in the case of a measurement on a cloud of particles.

FIG. 7 shows another application of a device according to the invention.

### DETAILED DESCRIPTION OF PARTICULAR EMBODIMENTS

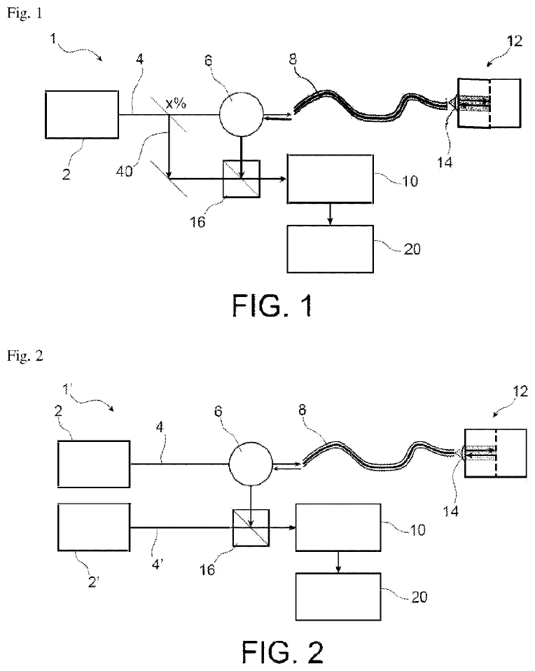

In the rest of this document, mention is made more specifically of laser radiation with a frequency of 30 THz (or with a wavelength of approximately 10 μm), but the teaching of the present application is not limited to this frequency or to this wavelength and can be generalised to the whole of the 100 THz and approximately 21 THz frequency domain or to all the wavelengths between 3 μm and 14 μm, and in particular between 8 and 12 μm.

[FIG. 1] shows an example embodiment of a device 1 according to the invention.

It includes a continuous laser radiation source 2, for example a laser source of the QCL type (“Quantum Cascade Laser”) or of the ICL type (“Interband Cascade Laser”), at a wavelength of approximately 10 μm (i.e. a frequency of approximately 30 THz) or 14 μm (21.4 THz). The beam of this type of laser is particular adapted (through its penetration power and its small size compared with the RIF systems) to penetrate material, with a view to detecting the propagation velocity, or optionally other characteristics, of a shock therein.

In a variant, it is possible to use a pulse source that has long pulses (for example with a duration greater than or equal to 100 μs), produced for example by a continuous laser provided with a beam interrupter. Short pulses (for example with a duration of less than 100 μs) would result in poor-quality interferences.

The beam 4 produced by this source is sent to a circulator 6 and is thus transmitted to a fibre 8, preferably a microstructured fibre, preferably monomode (which affords better contrast on the interferences), produced for example in a glass with a Te₂As₃Se₅ composition (also referred to as “TAS” glass). The losses in this type of fibre are small, of the order of 1 dB/m.

A small part (x %) 40, for example between 1% and 10% (for example 5%) of the beam 4 emitted by the source 2 is taken and sent to a rapid detection device 10, for example a photodiode coupled to a transimpedance circuit, which makes it possible to amplify the signal and to convert the current into voltage.

Means 16 forming a coupler make it possible to combine a beam that returns from the material 12, after having been reflected or diffused therein, with this part 40 of the beam taken from the beam generated by the source 2.

To maximise the interferences, the two signals preferably have similar amplitudes. Since the probe beam has losses, more power is sent to the target to receive a signal of the same order of magnitude as the signal 40 taken off.

At the exit from the fibre 8, the beam is directed to a sample 12, for example a sample of material such as TNT (or trinitrotoluene, C₇H₅N₃O₆), or RDX (or cyclo-trimethylene-trinitramine, C₃H₆N₆O₆), or HMX (or cyclo-tetramethylene-tetranitramine, C₄H₈N₈O₈), which are all transparent at the wavelengths envisaged in the context of the present application. The invention can moreover be implemented with highly varied materials, unlike a system of the “HV” type, by means of which only very few materials can be studied at the core.

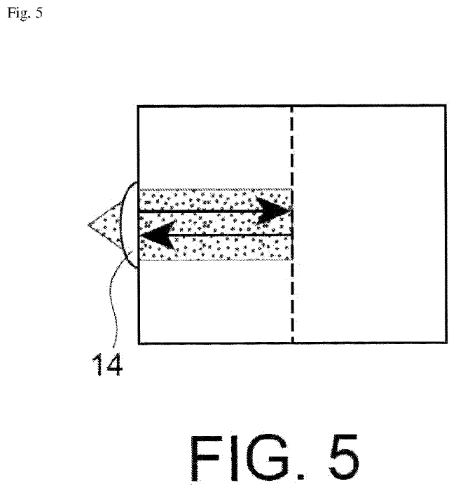

Means 14 forming a collimator, for example a lens, make it possible to focus the radiation towards the zone of interest inside the sample (solid, liquid, cloud of particles). Preferably, these collimation means are provided with one or more layers that are non-reflecting at the working wavelength. Preferably again, and as illustrated in [FIG. 5], these means 14 are applied directly against the target 12 that the beam must penetrate to avoid having a layer of air and spurious reflections at the surface of the collimator and of the sample.

The beam reflected or, at a minimum, diffused by the sample is partly collected and transmitted by the fibre 8 to the circulator 6, which sends it to the coupler 16, in which it combines with the beam 40 taken from the initial laser radiation (the homodyne case), and then to the rapid detector 10; the latter detects the interferences between these two beams.

Processing means 20 process the detected signal; they are in particular able, from the interference signal, to calculate the velocity of a wavefront on which the incident beam was reflected. The means 20 include for example a computer or a microcomputer able to or programmed for processing the interference signals and calculating the velocity of the object, for example of the wavefront, on which the incident beam was reflected. Preferably, the interference signal or signals is/are processed by Fourier transform or by wavelet transform of the interference signal or by two-phase processing.

The spatial resolution of a system according to the invention is lower than that of the HV systems (for example of the order of 5 to 10 times lower) but very much higher than that of the RIF systems (for example of the order of 300 to 1000 times higher). This spatial resolution is related to the size of the beam at the point where it is wished to detect the velocity. However, this size depends on the wavelength: for a wavelength of approximately 10 μm it is approximately 1 mm, whereas for a wavelength of 3.3 mm (and therefore well beyond the range in which the invention is implemented) this size is more than 1 cm. The invention is therefore particular adapted to making a velocity measurement with a very fine spatial resolution. It consequently makes it possible to direct a plurality of beams from the same source or at the same wavelength to the core of the target, in order to make several simultaneous measurements. The device of [FIG. 1] can moreover be adapted to use several beams, each generated by a laser source, for example of the type described above (QCL or ICL laser source); an example of a device using several beams is given in FR3098603.

The temporal resolution of the system according to the invention is also lower than that of the HV systems (for example of the order of 5 to 10 times lower) but very much higher than that of the RIF systems (for example of the order of 300 to 1000 times higher). This temporal resolution is approximated by the Doppler velocity (equal to 2.V/λ, where V is the velocity to be detected and λ the wavelength used). Since the invention uses wavelengths of between 3 μm and 14 μm, the temporal resolution thereof is much better than that of the systems of the RIF type. This good temporal resolution furthermore makes it possible to obtain a large number, typically several thousands, of interference fringes, for example a number of fringes of between 5000 and 50,000 for a velocity of 8000 m/s during 10 μs, very much greater than the number of fringes obtained in RIF technique (which makes it possible to obtain a few tens thereof, for example 50, under the same conditions). The number of fringes obtained by a device according to the invention therefore makes it possible to implement a processing by Fourier or wavelet transform, or with two phases, with a view to measuring the velocity of a shock or of a detonation. Reference can be made for example to the article by Julien Devlaminck et al. “Digital signal processing for velocity measurements in dynamical material's behaviour studies”, Rev. Sci. Instrum. 85, 035109 (2014), or to the article by V M Bel'skii et al., entitled “Microwave diagnostics of shock-wave and detonation processes”, which appeared in Combustion, Explosion and Shock Waves, Vol. 47, No. 6, pp. 639-650, (2011). The two-phase technique makes it possible to obtain a measurement of the movement; the derivative of the movement signal can then be calculated to obtain the velocity.

The Doppler frequency of a shock that can propagate at 8000 m/s (the order of magnitude of the values normally encountered on energetic materials in which a shock takes place) is 1.6 GHz at a wavelength of 10 μm, which is easily recordable, and detection is possible with the small bandwidth required at this wavelength. More generally, in the context of the present invention, it is sought to detect velocities of shocks or detonations that occur in a material and are between 5000 m/s and 10,000 m/s or surface velocities between 100 and 2000 m/s. The relatively low Doppler frequency that is to be detected is due to the use of a fairly long wavelength, between 3 μm and 14 μm.

When a velocity measurement is made by means of a device according to one of the embodiments of the present invention, example the one illustrated in [FIG. 1], a laser beam is produced by the laser source 2 and directed towards the inside of the sample of material 12. As explained above, a part 40 of the beam produced by the source is also taken off and sent to the coupler with a view to interfere with the beam that is reflected by the sample.

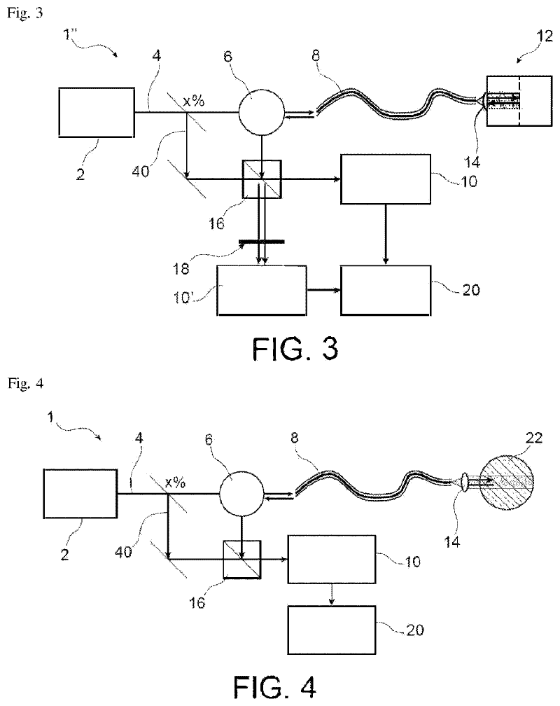

Moreover, a shock is produced in the latter. This shock propagates in the material for a period of approximately a few μs, for example between 1 μs and 10 μs. The laser beam is reflected by the wavefront that results from the shock or from the detonation and this reflected beam is sent to the circulator 6 by means of the fibre 8. The circulator sends this beam to the coupling means 16, where it interferes with the signal 40, which was taken directly from the beam output from the source 2. These interferences are detected by the detection means 10 and processed by the means 20 to deduce therefrom the velocity of the wavefront.

[FIG. 2] shows a “heterodyne” variant 1′ of the device according to the invention: it comprises two laser sources 2, 2′. The other numerical references designate the elements identical to those already described above. This device, the beam reflected by the sample 12 interferes with a beam 4′ of a second laser source 2′. The other aspects and advantages described above apply to this variant of the device according to the invention.

[FIG. 3] shows a variant 1″ of a device according to the invention, with two-phase processing: numerical references identical to those in [FIG. 1] designate therein the same elements; in addition, a half-wave plate 18 makes it possible to phase shift the two signals, which will interfere and be detected by the means 10′ (identical or similar to the means 10 and already described above). The means 20 thus make it possible to obtain a measurement of the movement of the target; the derivative of the movement signal can next be calculated, for example by the same means 20, to obtain the velocity; from this point of view, this technique is less favourable than those that use a Fourier transform or a wavelet processing, which make it possible to obtain the velocity or an estimation thereof directly.

[FIG. 4] shows an application of a device 1 according to the invention to measurement on a cloud 22 of particles: numerical references identical to those in [FIG. 1] designate therein the same elements. The other aspects and advantages described above apply to this variant of the device according to the invention.

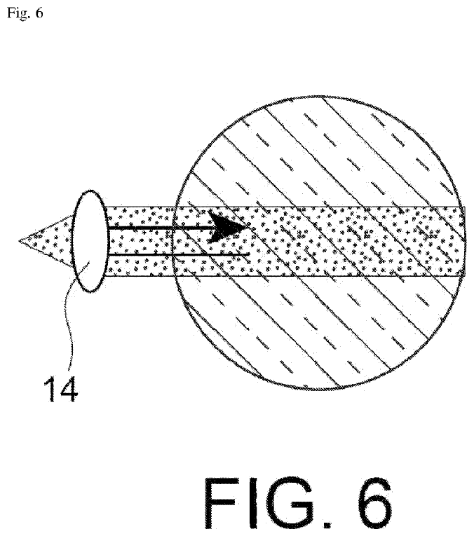

Preferably again, and as illustrated in [FIG. 6], the collimation means 14 are disposed as close as possible to the target 22 to avoid having a layer of air and spurious reflections on the surface of the collimator and of the target.

The other assemblies or devices 1′, 1″ of FIGS. 2 and 3 could also be applied to a measurement on a cloud 22 of particles.

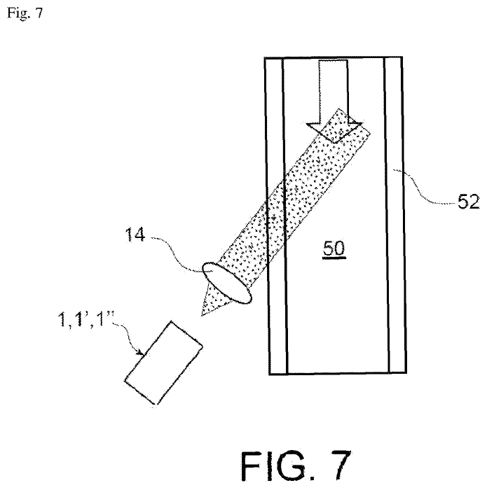

A device 1, 1′, 1″ according to the invention, according to any one of the embodiments thereof, also applies to measuring flow velocities of a fluid 50 circulating in a pipe (or a tube or a channel) 52. In this application, the beam is reflected or is diffused, but weakly, on the particles in the fluid. It therefore passes through a tube 52 opaque in the visible or near infrared but fairly transparent in the medium infrared. This application is illustrated schematically in [FIG. 7]; the measurement is made by Doppler effect, with high spatial resolution. The good spatial resolution is related to the same characteristics as those that were indicated above in the case of detecting the velocity of a shock. Reference 14 again designates the means of collimating the incident beam.

1. A device for measuring velocity, or a distribution of velocities, comprising:
at least one first laser radiation source that emits a laser beam with a wavelength of between 3 and 14 μm;
at least one optical fibre for directing a radiation produced by the at least one first laser radiation source, from a first end of the fibre to a second end thereof;
detection means, for detecting an interference signal between at least one beam emitted by the at least one first laser radiation source and a beam reflected or diffused by a sample or object; and
processing means, for processing the interference signal and to calculating a propagation velocity, or a distribution of propagation velocities, of a sample or object on which an incident beam was reflected or diffused.

2. The device according to claim 1, comprising the detection means being configured to detect an interference signal between at least one beam emitted by the at least one first laser radiation source and the beam reflected or diffused by the sample or object.

3. The device according to claim 1, comprising the detection means being configured to detect an interference signal between at least one beam emitted by a second laser radiation source and the beam reflected or diffused by the sample or object.

4. The device according to claim 3, wherein at least one of the first and the second laser radiation source is of a QCL type (“Quantum Cascade Laser”) or ICL type (“Interband Cascade Laser”) or a continuous source.

5. The device according to claim 1, comprising the fibre being of monomode and/or microstructured or hollow-core fibre type.

6. The device according to claim 1, comprising a bandwidth of the detection means being between approximately 20 MHz and 2 GHz.

7. The device according to claim 3, comprising at least one of the first laser radiation source and the second laser radiation source producing a beam a diameter of which is less than 3 mm.

8. The device according to claim 1, further comprising collimation means.

9. The device according to claim 1 comprising the interference-signal processing means being configured to produce at least one sliding Fourier transform of the interference signals or a wavelet transform.

10. The device according to claim 1, further comprising means for phase shifting part of the beam emitted by the at least one first laser radiation source and part of the beam reflected or diffused by the sample, and means for detecting an interference signal between the emitted and reflected beams, the interference-signal processing means being configured to implement at least one two-phase processing.

11. A method for measuring velocity, or a distribution of velocities, using the device according to claim 1, wherein:
the second end of the optical fibre is directed towards a sample or an object inside which a velocity of a movement, or a distribution of velocities of movements, is to be detected,
the incident beam of the at least one first laser source penetrates the sample or the object and is reflected or diffused on an interior part of the sample or the object, which moves at a first velocity or in accordance with a distribution of velocities;
the reflected or diffused beam and a part of the beam emitted by the at least one first laser radiation source or a second laser radiation source form interferences detected by the detection means; and
the first velocity, or the distribution of velocities, is calculated from the interferences.

12. The method according to claim 11, wherein a shock is produced inside the sample or object, the incident laser beam being reflected or diffused on a wavefront produced by the shock.

13. The method according to claim 12, wherein the sample or the object includes an explosive material such as TNT (or trinitrotoluene, C₇H₅N₃O₆), or RDX (or cyclo-trimethylene-trinitramine, C₃H₆N₆O₆), or HMX (or cyclo-tetramethylene-tetranitramine, C₄H₈N₈O₈), or an inert material.

14. The method according to claim 11, wherein the object is or includes a channel or a pipe or a tube inside which or from which a fluid moves, the incident laser beam being reflected or diffused on moving particles contained in the fluid.

15. The method according to claim 11, wherein the velocity is calculated by Fourier transform of the interference signal or by wavelets or by two-phase processing.

16. The method according to claim 11, wherein a plurality of laser beams are directed towards the sample or the object.
